(19) United States
(12) Patent Application Publication
(10) Pub. No.: US 2024/0266821 A1
(43) Pub. Date: Aug. 8, 2024

(54) CONTROL UNIT

(71) Applicant: DENSO CORPORATION, Kariya-city (JP)

(72) Inventor: HIDEKI KABUNE, Kariya-city (JP)

(21) Appl. No.: 18/637,721

(22) Filed: Apr. 17, 2024

Related U.S. Application Data
(63) Continuation of application No. PCT/JP2022/038963, filed on Oct. 19, 2022.

(30) Foreign Application Priority Data
Oct. 22, 2021 (JP) 2021-173089

(51) Int. Cl. H02H 3/20; B62D 5/04

(52) U.S. Cl. CPC H02H 3/20; B62D 5/0484

(57) ABSTRACT

A control unit includes multiple controllers, an intersystem communication circuit, an internal power supply circuit and a protection circuit. The controllers control a load, and are connected to individual circuit arrangements. The individual circuit arrangements are defined as systems. The intersystem communication circuit is connected between one of the systems and remainder of the systems. The internal power supply circuit is included in each system. The internal power supply circuit supplies electric power to corresponding one of the controllers and the intersystem communication circuit. The protection circuit cuts off an internal power supply line between the internal power supply circuit and the intersystem communication circuit or limits supply of the electric power to the intersystem communication circuit, in response to the occurrence of an overvoltage abnormality in which an output voltage of the internal power supply circuit is in an overvoltage state.

### CROSS REFERENCE TO RELATED APPLICATIONS

The present application is a continuation application of International Patent Application No. PCT/JP2022/38963 filed on Oct. 19, 2022, which designated the U.S. and claims the benefit of priority from Japanese Patent Application No. 2021-173089 filed on Oct. 22, 2021. The entire disclosures of all of the above applications are incorporated herein by reference.

### TECHNICAL FIELD

The present disclosure relates to a control unit.

### BACKGROUND

An electric power steering system may be equipped with redundant drive. For example, there may be galvanic isolation between two drive electronic devices.

### SUMMARY

The present disclosure describes a control unit having multiple controllers, an intersystem communication circuit, an internal power supply circuit, and a protection circuit.

### BRIEF DESCRIPTION OF DRAWINGS

Objects, features and advantages of the present disclosure will become more apparent from the following detailed description made with reference to the accompanying drawings. In the drawings:

FIG. 1 is a schematic configuration diagram of a steering system according to a first embodiment;

FIG. 2 is a block diagram showing an electronic control unit (ECU) according to the first embodiment;

FIG. 3 is a circuit diagram showing a protection circuit according to the first embodiment;

FIG. 4 is a circuit diagram showing a protection circuit according to the first embodiment;

FIG. 5 is a circuit diagram showing a protection circuit in a case of having a triple system according to the first embodiment;

FIG. 6 is a circuit diagram showing a protection circuit in a case of having a common ground according to the first embodiment;

FIG. 7 is a schematic diagram showing an integrated circuit (IC) included in an internal power supply circuit according to the first embodiment;

FIG. 8 is a schematic diagram showing a fuse pattern according to the first embodiment;

FIG. 9 is a circuit diagram showing a protection circuit according to a second embodiment;

FIG. 10 is a circuit diagram showing a protection circuit in a case of having a triple system according to the second embodiment;

FIG. 11 is a circuit diagram showing the protection circuit in a case of having a common ground according to the second embodiment;

FIG. 12 is a circuit diagram showing a protection circuit according to a third embodiment;

FIG. 13 is a circuit diagram showing the protection circuit in a case of having a triple system according to the third embodiment;

FIG. 14 is a circuit diagram showing the protection circuit in a case of having a common ground according to the third embodiment;

FIG. 15 is a circuit diagram showing a protection circuit according to a fourth embodiment;

FIG. 16 is an explanatory diagram showing output characteristics of an overcurrent limiter circuit according to the fourth embodiment;

FIG. 17 is a circuit diagram showing a protection circuit in a case of having a triple system according to the fourth embodiment; and

FIG. 18 is a circuit diagram showing a protection circuit in the case of having a common ground according to the fourth embodiment.

### DETAILED DESCRIPTION

In a control circuit included in multiple systems, if a fault occurs in which a voltage of an internal power supply that supplies electric power to a microcomputer or other devices increases, the normal control circuit may have a breakdown due to an increase in the voltage of the communication line. As a countermeasure for the above-mentioned situation, it is possible to provide an isolated communication buffer such as a photocoupler for intersystem communication. Since the isolated communication buffer is a relatively large element, it is necessary to secure a relatively large mounting area on a board.

According to an aspect of the present disclosure, a control unit includes multiple controllers, an intersystem communication circuit, an internal power supply circuit and a protection circuit. The controllers control a load, and are connected to individual circuit arrangements. The individual circuit arrangements are defined as systems. The intersystem communication circuit connects one of the systems to another of the systems. The internal power supply circuit is included in each of the systems. The internal power supply circuit supplies electric power to corresponding one of the controllers and the intersystem communication circuit. The protection circuit cuts off an internal power supply line between the internal power supply circuit and the intersystem communication circuit or limits supply of the electric power to the intersystem communication circuit, in response to the occurrence of an overvoltage abnormality in which an output voltage of the internal power supply circuit is in an overvoltage state.

The following describes multiple embodiments with reference to the drawings. Hereinafter, in the respective embodiments, substantially the same configurations are denoted by identical symbols, and repetitive description will be omitted.

### First Embodiment

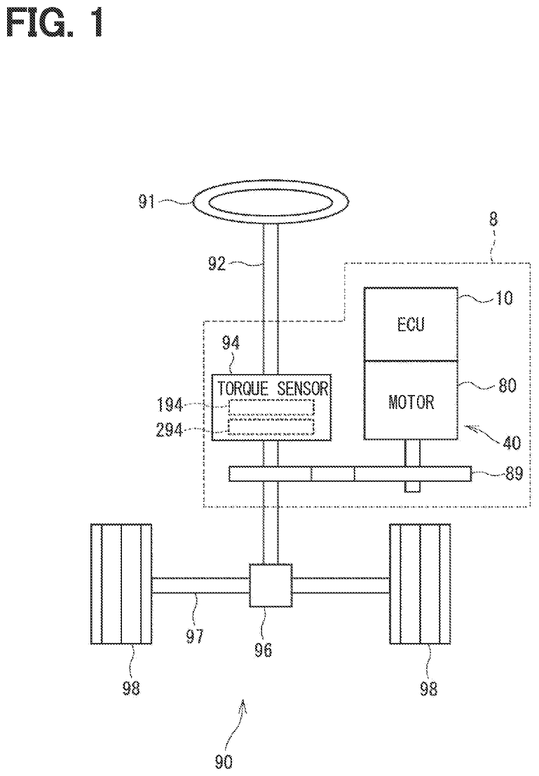

The first embodiment is shown in FIGS. 1 to 8. An electronic control unit (ECU) 10 as a control unit according to the present embodiment is adapted to an electric power steering device 8 for assisting a steering operation of, for example, a vehicle. FIG. 1 shows a configuration of a steering system 90 including the electric power steering device 8. The steering system 90 includes a steering wheel 91 as a steering member, a steering shaft 92, a pinion gear 96, a rack shaft 97, wheels 98, the electric power steering device 8, and the like.

The steering wheel 91 is connected to the steering shaft 92. A torque sensor 94 is provided on the steering shaft 92 to detect a steering torque. The torque sensor 94 has a first sensor unit 194 and a second sensor unit 294, each of which is capable of detecting its own fault. A pinion gear 96 is provided at an axial end of the steering shaft 92. The pinion gear 96 engages with the rack shaft 97. A pair of road wheels 98 is coupled at both ends of the rack shaft 97 via, for example, tie rods.

When a driver of the vehicle rotates the steering wheel 91, the steering shaft 92 connected to the steering wheel 91 rotates. A rotational motion of the steering shaft 92 is converted into a linear motion of the rack shaft 97 by the pinion gear 96. The pair of road wheels 98 is steered to an angle corresponding to a displacement amount of the rack shaft 97.

The electric power steering device 8 includes a driver 40 and the reduction gear 89. The driver 40 includes a motor 80, the ECU 10, and the like. The reduction gear 89 as a power transmission unit reduces the rotation of the motor 80 and transmits it to the steering shaft 92. In other words, the electric power steering device 8 according to the present embodiment is a so-called “column assist type”, but may be a so-called “rack assist type” which transmits the rotation of the motor 80 to the rack shaft 97.

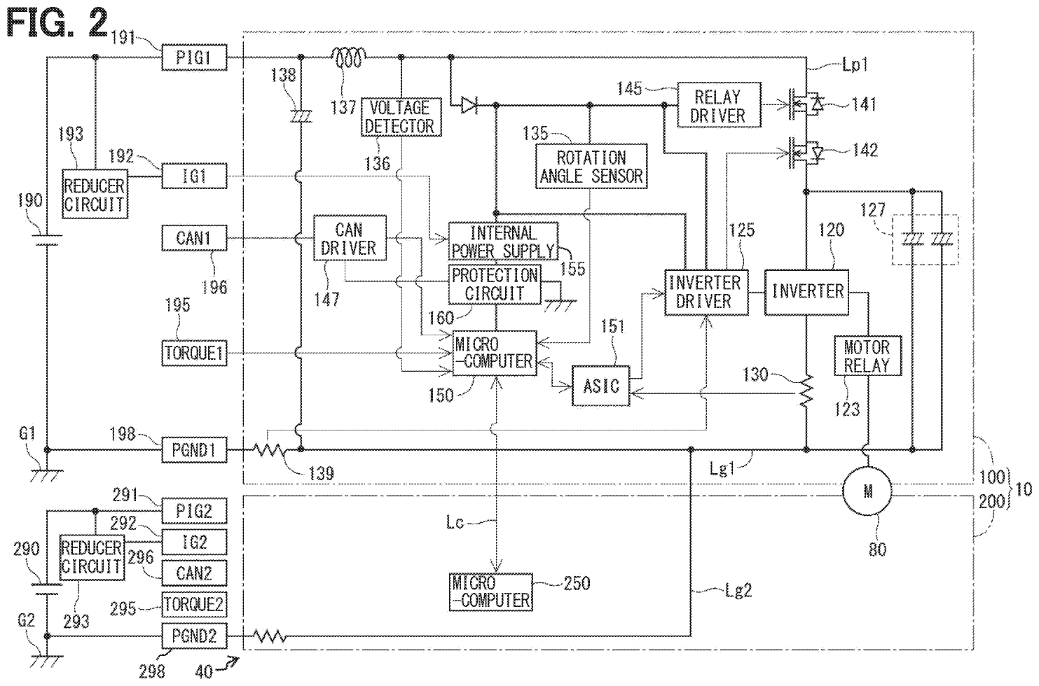

The motor 80 outputs a whole or a part of an assist torque required for a steering operation. As shown in FIG. 2, the motor 80 is driven by electric power supplied from batteries 190 and 290, each of which is a direct current power supply to rotate the reduction gear 89 in forward and reverse directions. The motor 80 is a three-phase brushless motor, but other motors may be used.

As shown in FIG. 2, the motor 80 has two sets of motor windings (not shown). In the following, a configuration related to energization control of one motor winding may also be referred to as a first circuit unit 100, and a configuration related to energization control of the other one motor winding may also be referred to as a second circuit unit 200. Electronic components included in the first circuit unit 100 and the second circuit unit 200 mount on a board (not shown). All electronic components may mount on a single board. The single board may be divided into multiple boards, and the electronic components may mount on the multiple boards. The first circuit unit 100 may also be referred to as a first circuit arrangement, and the second circuit unit 200 may also be referred to as a second circuit arrangement.

In the present embodiment, since the circuit arrangement of the first circuit unit 100 and the circuit arrangement of the second circuit unit 200 are substantially identical, the following mainly describes the detailed circuit arrangement of the first circuit unit 200. The combination of the first circuit unit 100 and the motor winding connected to the first circuit unit 100 is referred to as the first system, while the combination of the second circuit unit 200 and the motor winding connected to the second circuit unit 200 is referred to as the second system. In the present disclosure, the first system may be referred to as a local system or a self-system, and the second system may be referred to as an external system or an additional system. However, when the second system is referred to as a local system or a self-system, the first system is referred to as an external system or an additional system.

The first circuit unit 100 includes, for example, an inverter 120, a motor relay 123, an inverter driver circuit 125, a current detector 130, a rotation angle sensor 135, a voltage detector 136, a power supply relay 141, a reverse-connection protection relay 142, a relay driver circuit 145, a communication driver circuit 147, a microcomputer 150, an integrated circuit 151, an internal power supply circuit 155, and a protection circuit 160.

The first circuit unit 100 is supplied with electric power from the first battery 190. In the first embodiment, the first battery 190 is, for example, a 48-volt power supply, and supplies electric power to the first circuit unit 100 via a PIG terminal 191. The electric power of the first battery 190 is reduced to, for example, 12 volts by a reducer circuit 193, and supplies the electric power to the first circuit unit 100 via an IG terminal 192. The configuration related to boosting voltage or reducing voltage can be designed as appropriate, according to a voltage of the first battery 190 and a voltage required by the first circuit unit 100.

The first circuit unit 100 is connected to a first sensor unit 194 of a torque sensor 94 via a torque sensor terminal 195, and is connected to a vehicle communication network (not shown) via a communication terminal 196. The vehicle communication network is connected to the microcomputer 150 via the communication driver circuit 147 so that various information can be transmitted and received. The present disclosure describes an example that the vehicle communication network is controller area network (CAN). However, any other standard such as CAN with Flexible Data rate (CAN-FD) or FlexRay may be adopted. The first circuit unit 100 is connected to a ground G1 via a ground terminal 198.

The second circuit unit 200 is supplied with electric power from a second battery 290. In the present embodiment, the second battery 290 is, for example, a 48-volt power supply, and supplies electric power to the second circuit unit 200 via a PIG terminal 291. The electric power of the second battery 290 is reduced to, for example, 12 volts by a reducer circuit 293, and supplies the electric power to the second circuit unit 200 via an IG terminal 292. The second circuit unit 200 is connected to a second sensor unit 294 of a torque sensor 94 via a torque sensor terminal 295, and is connected to a vehicle communication network (not shown) via a communication terminal 296. The vehicle communication network to which the first circuit unit 100 is connected and the vehicle communication network to which the second circuit unit 200 is connected may be identical or different. The second circuit unit 100 is connected to a ground G2 via a ground terminal 298. In the present embodiment, the ground G1 of the first system and the ground G2 of the second system are isolated.

The inverter 120 is a three-phase inverter that converts the electric power of the motor winding of the first system. The motor relay 123 is provided between the inverter 120 and the motor winding. The motor relay 123 can execute switchover between disconnection and connection of the inverter 120 and the motor winding. The inverter driver circuit 125 outputs a drive signal related to turning on or off the reverse-connection protection relay 142 and the switching elements (not shown) included in the inverter 120 and the motor relay 123. The capacitor 127 is connected to the inverter 120 in parallel, and smoothens the electric power supplied to the inverter 120 by storing charge.

The current detector 130 is, for example, a shunt resistor provided in each phase, and detects the current flowing through each phase of the motor winding. The detection value is output to the microcomputer 150 via the integrated circuit 151. In FIG. 2, the integrated circuit 151 is indicated as “ASIC”. The rotation angle sensor 135 detects the rotation of the motor 80, and outputs the detection value to the microcomputer 150.

The voltage detector 136 detects a voltage of a power supply line Lp1 connected to the PIG terminal 191, and outputs the detection value to the microcomputer 150. A choke coil 137 and a capacitor 138 included in a filter circuit are connected to the power supply line Lp1. The ground line Lg1 is provided with a disconnection detector 139 that detects a disconnection of the ground.

The power supply relay 141 and the reverse-connection protection relay 142 are provided at the power supply line Lp1. In a case where the relays 141, 142 are configured by a switching element such as a MOSFET having a parasitic diode, it may be desirable that two switching elements are connected in series so that the directions of the parasitic diodes are reversed. Thereby, even when the battery 190 is erroneously connected in the reverse direction, it is possible to prevent a reverse current from flowing. Further, the relays 141 and 142 may be mechanical relays. The relay driver circuit 145 outputs a drive signal related to turning on and off the power supply relay 141.

The microcomputers 150, 250 execute a variety types of calculation related to driving of the motor 80, and are provided to send and receive information mutually. The electric power from the internal power supply circuit 155 is supplied to the microcomputer 150. A capacitor 156 is connected to the internal power supply circuit 155 as illustrated in FIG. 4. The capacitor 156 stabilizes the output voltage of the internal power supply circuit 155.

If a fault occurs causing the output voltage (hereinafter referred to as “internal power supply voltage Vmi”) of the internal power supply circuit 155 supplying power to the microcontroller 150 and components related to intersystem communication to increase, there is a possibility that the fault may propagate by applying a voltage being in an overvoltage state to the external system that is normally functioning via the intersystem communication line Lc. As a countermeasure for the above situation, for example, an insulated communication buffer such as a photocoupler may be adopted for the intersystem communication. When the isolated communication buffer is a large device, it occupies a relatively large mounting area on the board.

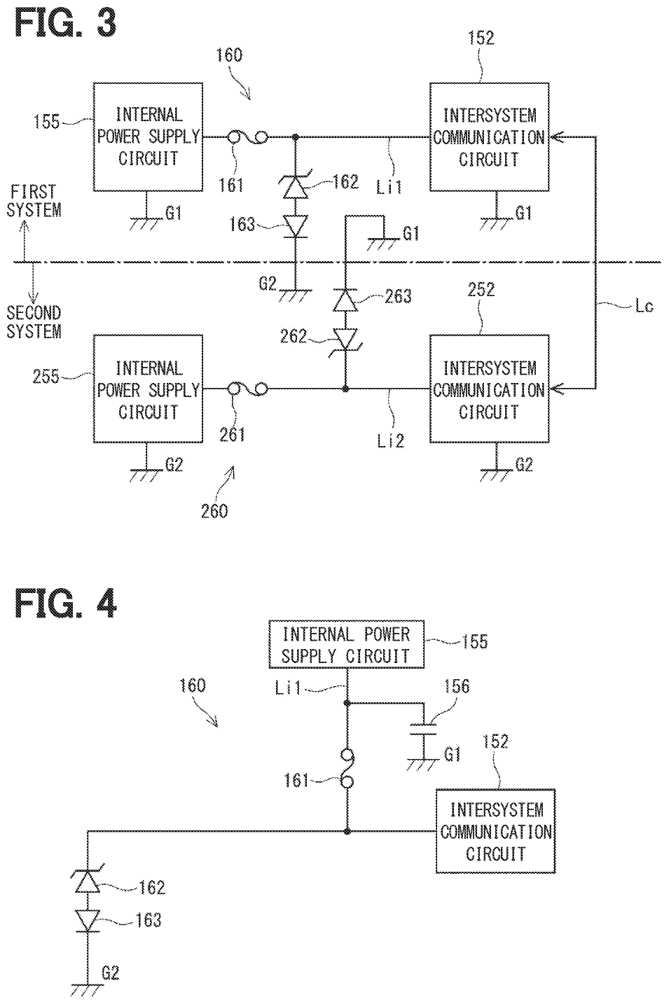

In the present embodiment, the protection circuit 160 is provided for the internal power supply circuit 155. The protection circuits 160, 260 are illustrated in FIGS. 3, 4. In FIG. 3, the interface circuits that connect different systems are collectively referred to as the intersystem communication circuits 152 and 252. These circuits include the MCU-integrated SCI (Serial Communication Interface) and SPI (Serial Peripheral Interface), general-purpose port signals, monitoring signals from other ICs, transceivers for CAN and LIN, as well as branches from sensor interfaces. From FIG. 4 onwards, the configuration in a single system is mainly described.

As shown in FIGS. 3, 4, the protection circuit 160 includes a fuse 161 and a Zener diode 162. The fuse 161 is provided at the internal power supply line Li1 that connects the internal power supply circuit 155 and the intersystem communication circuit 152. The cathode of the Zener diode 162 is connected to the internal power supply line Li1, and the anode of the Zener diode 162 is connected to the ground G2 being a ground in the external system via the diode 163. The diode 163 is provided between the Zener diode 162 and the ground G2. The diode 163 is provided for preventing a current from flowing into the first system when the ground G2 is floating.

The protection circuit 260 includes a fuse 261 and a Zener diode 262. The fuse 261 is provided at the internal power supply line Li2 that connects the internal power supply circuit 255 and the intersystem communication circuit 252. The cathode of the Zener diode 262 is connected to the internal power supply line Li2, and the anode of the Zener diode 262 is connected to the ground G1 being a ground in the external system via the diode 263. The diode 263 is provided between the Zener diode 262 and the ground G1. The diode 263 is provided for preventing a current from flowing into the second system when the ground G1 is floating.

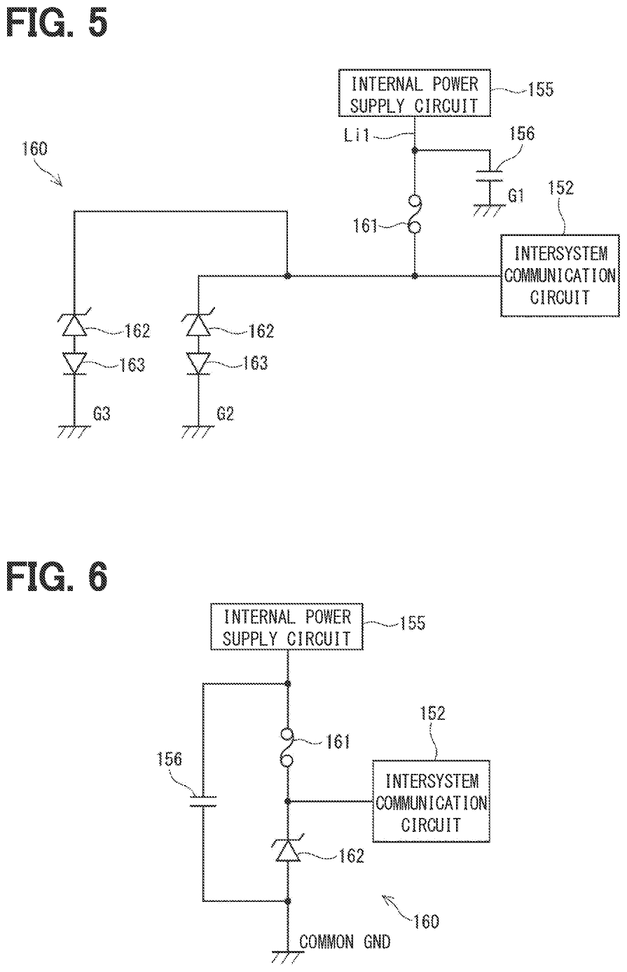

In addition, as shown in FIG. 5, when there are three or more systems and the grounds G1, G2, and G3 in the individual systems are isolated, the Zener diodes 162 and the diode 163 are provided for each system and connected to the grounds G2 and G3 in the external systems, respectively. As shown in FIG. 6, when the ground is common to each system, the diode 163 provided on the ground side of the Zener diode 162 can be omitted.

The following mainly describes the protection circuit 160. When the internal power supply line Li1 has a voltage being in the overvoltage state due to an abnormality in the internal power supply circuit 155, the fuse 161 is melt down as a large current flows in a case where the voltage of the internal power supply line Li1 becomes larger than the Zener voltage of the Zener diode 162. Accordingly, it is possible to prevent a high voltage due to an abnormality in the internal power supply circuit 155 from being applied to the second system as the external system. In the present disclosure, the voltage being in the overvoltage state may be simply referred to as overvoltage.

The protection circuit 160 is constructed so that the fuse 161 is melt down before the Zener diode 162 has an open-circuit fault. In a case where If denotes a fusing current of the fuse 161 and Iz denotes the Zener disconnection current, the fuse 161 and the Zener diode 162 are constructed so that If is smaller than Iz.

Generally, when a bare chip of a Zener diode is subjected to an overload due to an overvoltage, a short circuit occurs between the cathode and anode of the Zener diode. At this time, when the current after the occurrence of the short circuit is large, the bonding may be cut and an open-circuit fault may occur. Accordingly, a metal clip connection structure, which is less likely to cause an open-circuit fault, may be adopted as the Zener diode 162 of the protection circuit 160.

In the present embodiment, a board-mounted fuse such as a square chip current fuse or a mold-mounted current fuse is used as the fuse 161. A chip resistor with low resistance (for example, several ohms) and low rated current may be used as the fuse 161.

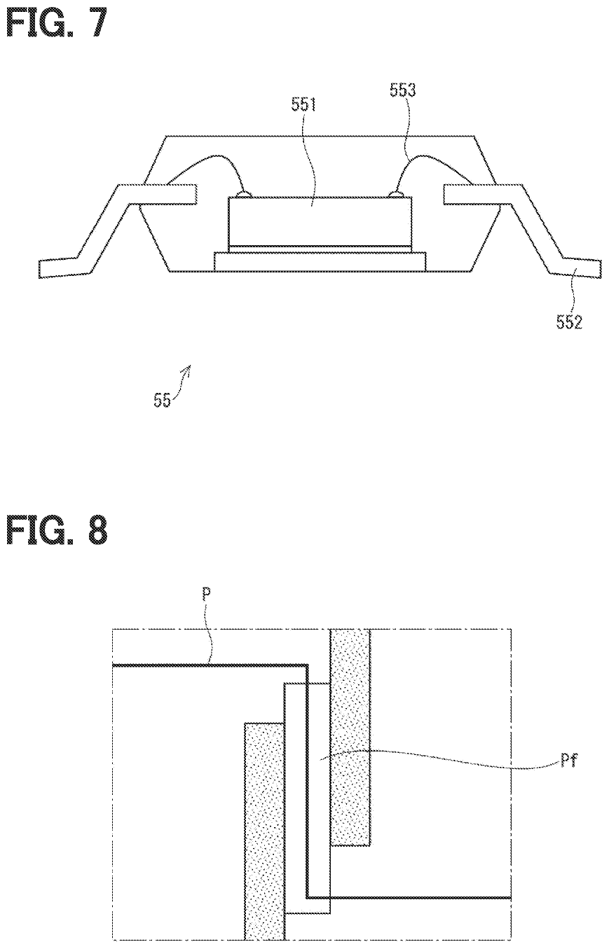

As illustrated in FIG. 7, an integrated circuit (IC) 55 included in the internal power supply circuit 155 includes a die 551, an output terminal 552 connected to the intersystem communication circuit 152, and a bonding wire 533 connecting the die 551 and the output terminal 552. The bonding wire 553 may have a function as the fuse by making the disconnection current of the bonding wire 553 to have be smaller than the disconnection current of the Zener diode 162. In this case, the design is made so that dependent faults such as overheating and faults in other systems do not occur before the bonding wire 553 is melted down.

As shown in FIG. 8, in the wiring pattern of the board included in the internal power supply line Li1, a fuse pattern Pf as a pattern being locally thinner than other locations may be formed as the fuse. In this case, it is necessary to design a board such that no other wiring provided at the regions above and below the layer where the fuse pattern Pf is formed. In FIG. 8, locations where no pattern is formed are shown in satin finish.

In the present embodiment, the protection circuit 160 is constructed such that the fuse 161 and the Zener diode 162 are connected in series between the internal power supply circuit 155 and the ground G2 of the external system. An overvoltage through the intersystem communication line Lc is prevented from being applied to the external system by melting down the fuse 161 in a case where an overvoltage of the internal power supply circuit 155 occurs. Therefore, when an overvoltage occurs in the internal power supply circuit 155, it is possible to prevent a fault from propagating to the external system via the intersystem communication circuit 152.

The ECU 10 includes the microcomputers 150, 250, the intersystem communication circuits 152, 252, the internal power supply circuits 155, 255, and the protection circuits 160, 260. The microcomputers 150 and 250 control driving of the motor 80. The circuit arrangement corresponding to each of the microcomputers 150, 250 is referred to as a system. The intersystem communication circuit 152 is connected to the external system that corresponds to the microcomputer 250.

The internal power supply circuit 155 is provided for each system, and supplies the electric power to the microcomputer 150 and the intersystem communication circuit 152. The protection circuit 160 may cut off the internal power supply line Li1 leading to the intersystem communication circuit 152 from the internal power supply circuit 155 or limit the power supply to the intersystem communication circuit 152, when the internal power supply voltage Vmi causes an overvoltage fault due to overvoltage. The internal power supply voltage Vmi is an output voltage of the internal power supply circuit 155.

Thus, it is possible to prevent fault propagation to the external system due to overvoltage caused by abnormality in the internal power supply circuits 155, 255 being applied to the external system via the intersystem communication circuits 152, 252.

When the ground in each system is isolated, the protection circuits 160 and 260 are connected to the ground of the external system. Thereby, it is possible to appropriately prevent overvoltage due to an abnormality in the internal power supply circuits 155 and 255 from being applied to the external system.

The protection circuit 160 according to the present embodiment includes the fuse 161 and the Zener diode 162. The fuse 161 is provided at the internal power supply line Li1. The Zener diode 162 is provided at the wiring connected between the ground and the fuse 161 on the intersystem communication circuit 152 side. When the internal power supply voltage Vmi has the occurrence of overvoltage abnormality caused by overvoltage, it is possible to cut off the internal power supply line Li1 by melting the fuse 161. Thereby, it is possible to appropriately prevent overvoltage due to an abnormality in the internal power supply circuits 155 and 255 from being applied to the external system.

The fuses 161, 261 are chip-like current fuses mounting on the board, or the chip resistors disconnected at a voltage being lower than the Zener diode. Therefore, the protection circuits 160, 260 can be made with relatively small components.

The fuse 161 may be a bonding wire 553 connected to the output terminal 552, which is connected to the intersystem communication circuit 152, inside the IC 55 included in the internal power supply circuit 155. Thus, the fuse 161 can be made without increasing the number of components.

The fuse 161 may serve as a fuse pattern Pf being locally formed thinner than other locations in the wiring pattern on the board included in the current path P connecting the internal power supply circuit 155 and the intersystem communication circuit 152. Thus, the fuse 161 can be made without increasing the number of components.

### Second Embodiment

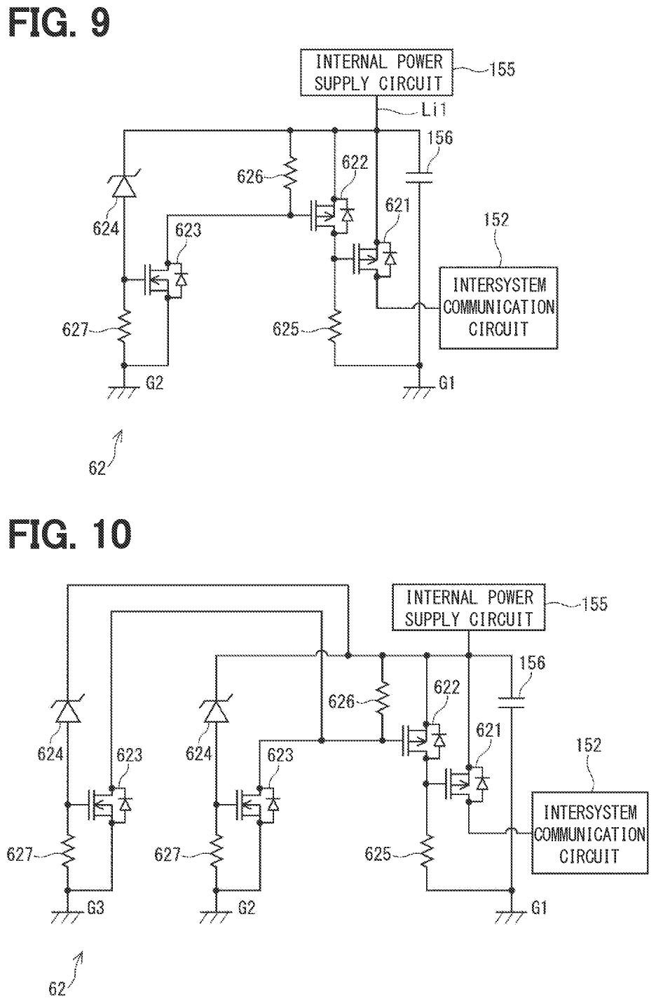

A second embodiment is shown in FIG. 9 to FIG. 11. The present embodiment is different from the embodiment described above in the protection circuit, and therefore, the following explanation mainly focuses on the first system. As shown in FIG. 9, the protection circuit 62 includes switching elements 621 to 623, a Zener diode 624, and resistors 625 to 627.

The switching elements 621 and 622 are P-channel MOSFETs, and are connected so that their sources are on the internal power supply circuit 155 side. The drain of the switching element 621 is connected to the intersystem communication circuit 152 side, and the gate of the switching element 621 is connected between the switching element 622 and the resistor 625. The drain of the switching element 622 is connected to the ground G1 via a resistor 625, and the gate of the switching element 622 is connected to the drain of the switching element 623.

The switching element 623 is an N-channel MOSFET. The source of the switching element 623 is connected to the ground G2 being a ground in the external system. The drain of the switching element 623 is connected to the gate of the switching element 622. The wiring, which connects the drain of the switching element 623 and the gate of the switching element 622, is connected to the internal power supply line Li1 via a resistor 626. The gate of the switching element 623 is connected to the anode side of the Zener diode 624. The cathode side of the Zener diode 624 is connected to the internal power supply line Li1, and the anode side of the Zener diode 624 is connected to the ground G2 via a resistor 627.

When the internal power supply circuit 155 is normal, no current flows to the Zener diode 624. Therefore, a gate voltage is applied to the switching elements 622 and 621 via the resistor 626, and the switching elements 622 and 621 are turned on. As a result, the electric power from the internal power supply circuit 155 is supplied to the intersystem communication circuit 152 via the switching element 621.

When the internal power supply line Li1 becomes overvoltage due to an abnormality in the internal power supply circuit 155, the internal power supply voltage Vmi becomes higher than the Zener voltage of the Zener diode 624. Thus, a gate voltage is applied to the switching element 623 via the Zener diode 624, and the switching element 623 is turned on. When the current from the internal power supply line Li1 flows to the switching element 623 side via the resistor 626, the voltage applied to the gate of the switching element 622 decreases, and the switching elements 622 and 621 are turned off. As a result, it is possible to prevent the overvoltage of the internal power supply circuit 155 from being applied to the external system via the intersystem communication circuit 152.

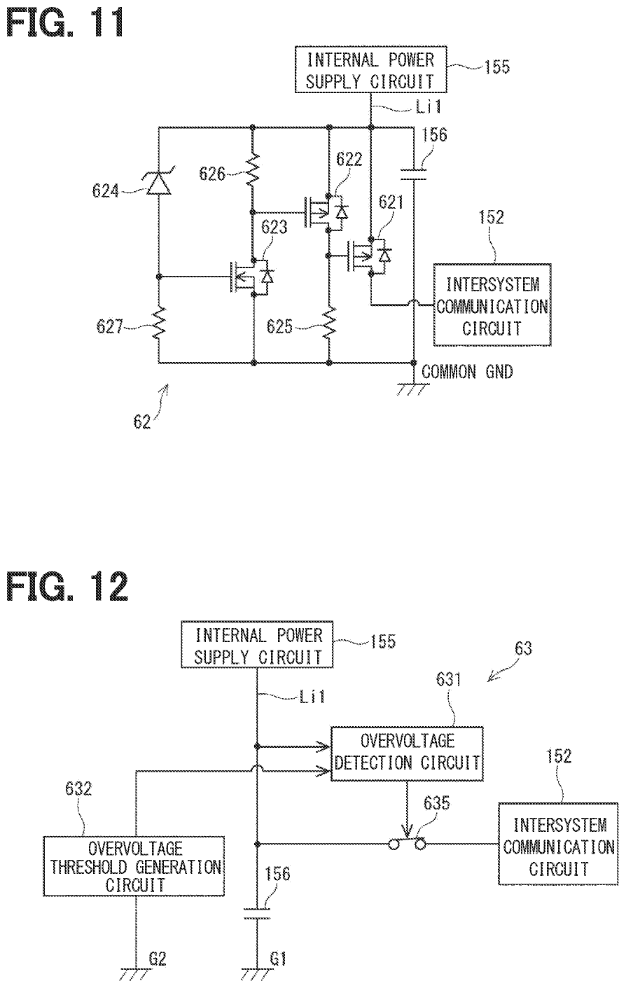

As shown in FIG. 10, when there are three or more systems and the ground of each individual system is isolated, the switching element 623, the Zener diode 624, and the resistor 627 are provided for the individual system and connected to the ground of individual system. As shown in FIG. 11, when multiple systems have a common ground, the source of the switching element 623 and the anode side of the Zener diode 624 are connected to the common ground.

The protection circuit 62 includes: the switching element 621 that is provided at the internal power supply line Li1; and the Zener diode 624 that is connected to the internal power supply line Li1 and the ground. The switching element 621 is turned on when the internal power supply voltage Vmi is normal, and is turned off when the internal power supply voltage Vmi is an overvoltage because a current flows to the Zener diode 624 side. Thereby, when an overvoltage of the internal power supply voltage Vmi occurs, the internal power supply line Li1 can be appropriately cut off. Further, the similar advantageous effects to those of the embodiment described above can also be achieved.

### Third Embodiment

A third embodiment is shown in FIG. 12 to FIG. 14. As shown in FIG. 12, a protection circuit 63 includes an overvoltage detection circuit 631, an overvoltage threshold generation circuit 632, and a cutoff relay 635. The internal power supply voltage Vmi is a voltage of the internal power supply line Li1. A comparative voltage Vref is a voltage generated in the overvoltage threshold generation circuit 632. The overvoltage detection circuit 631 compares the internal power supply voltage Vmi with the comparative voltage Vref, and turns off the cutoff relay 635 in a case where the internal power supply voltage Vmi is larger than the comparative voltage Vref. Although the cutoff relay 635 in the present embodiment is a semiconductor relay, the cutoff relay 635 may be a mechanical relay.

The overvoltage threshold generation circuit 632 is a circuit that generates an overvoltage threshold based on the ground G2 being a ground in the external system. The overvoltage threshold generation circuit 632 adopts, for example, a circuit provided with a Zener diode or a circuit for generating an arbitrary voltage by an amplifier for amplifying a bandgap voltage to generate a voltage value not exceeding the circuit breakdown voltage in the external system as the comparative voltage Vref.

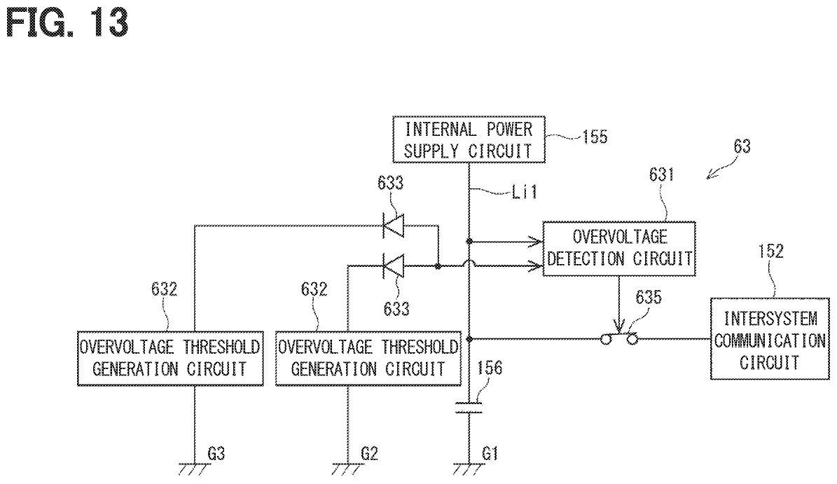

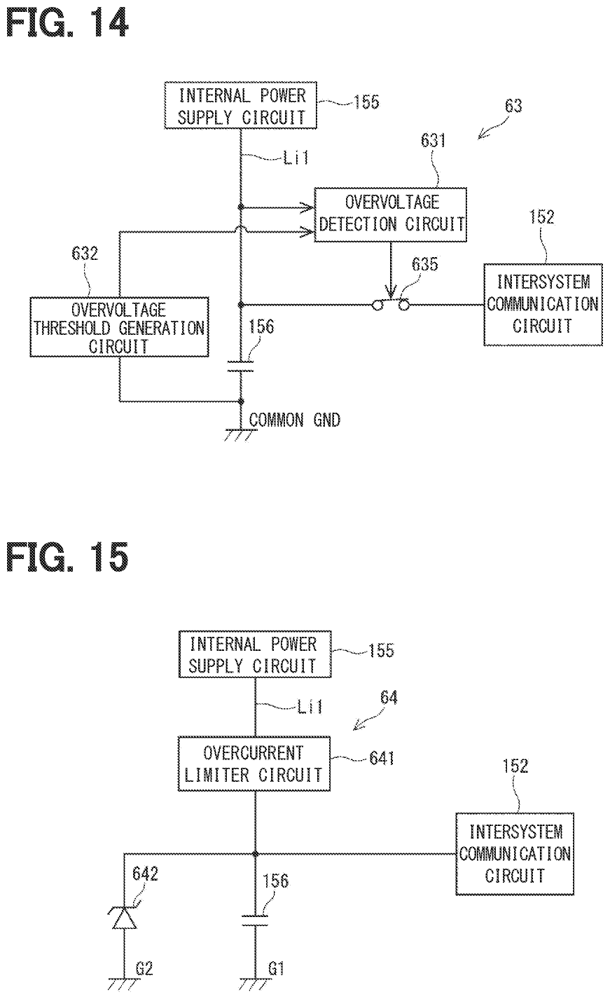

As shown in FIG. 13, when there are three or more systems and the ground in each individual system is isolated, the overvoltage threshold generation circuit 632 is provided for each system and is connected to the ground of each system. The diodes 633 are provided in the individual systems. By providing the diode 633, the lowest value among the comparative voltages Vref generated by the overvoltage threshold generation circuits 632 in the individual systems is output to the overvoltage detection circuit 631. This prevents circuit breakdown among the systems. As shown in FIG. 14, the multiple systems have a common ground, the overvoltage threshold generation circuits 632 are connected to the common ground.

When the internal power supply voltage Vmi exceeds the comparative voltage Vref, the cutoff relay 635 is turned off. Therefore, even if the internal power supply line Li1 becomes overvoltage, it is possible to prevent the high voltage exceeding the comparative voltage Vref from being applied to the external system via the intersystem communication circuit 152.

The protection circuit 63 includes: the overvoltage detection circuit 631 that monitors the internal power supply voltage Vmi; and the cutoff relay 635 that is provided at the internal power supply line Li1 and is turned off when an overvoltage of the internal power supply voltage Vmi is detected. Thereby, when an overvoltage of the internal power supply voltage Vmi occurs, the internal power supply line Li1 can be appropriately cut off. Further, the similar advantageous effects to those of the embodiment described above can also be achieved.

### Fourth Embodiment

A fourth embodiment is shown in FIG. 15 to FIG. 18. As shown in FIG. 15, a protection circuit 64 includes an overcurrent limiter circuit 641 and a Zener diode 642. The overcurrent limiter circuit 641 detects the current of the output line using a current mirror circuit of an output element or a current detection element (for example, a Hall integrated circuit or a shunt resistor), and limits the output circuit. The overcurrent limiter circuit 641 may be built into the internal power supply circuit 155 as long as its independence is maintained.

The Zener diode 642 is provided between the overcurrent limiter circuit 641 and the ground G2 being a ground in the external system. The Zener diode 642 is provided for preventing chain breakdown affecting the external system due to overvoltage.

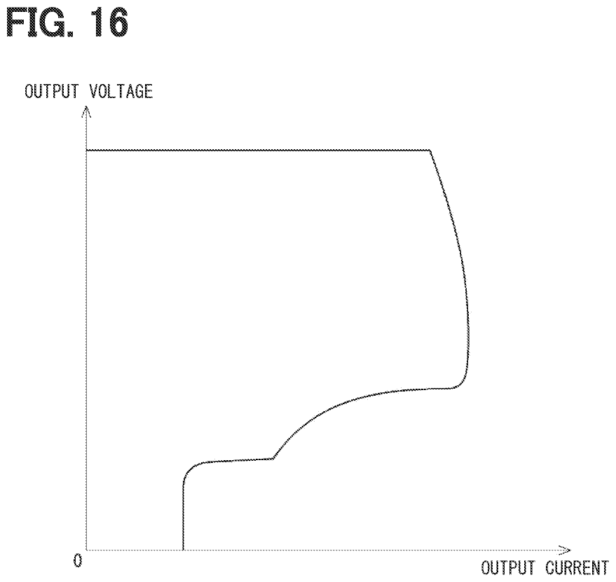

The output current limit value Ilim of the overcurrent limiter circuit 641 is set to be greater than the maximum total current consumption Imax of the circuit that supplies power from the internal power supply circuit 155, and also set to a value that does not cause open-circuit breakdown of the Zener diode 642 or overheating that affects the external system. By designing the overcurrent limiter circuit 641 to have an output limitation characteristic shown in FIG. 16, it is possible to construct the protection circuit 64 using a relatively small-sized Zener diode 642, which has a Fold-back Type Drooping Characteristic.

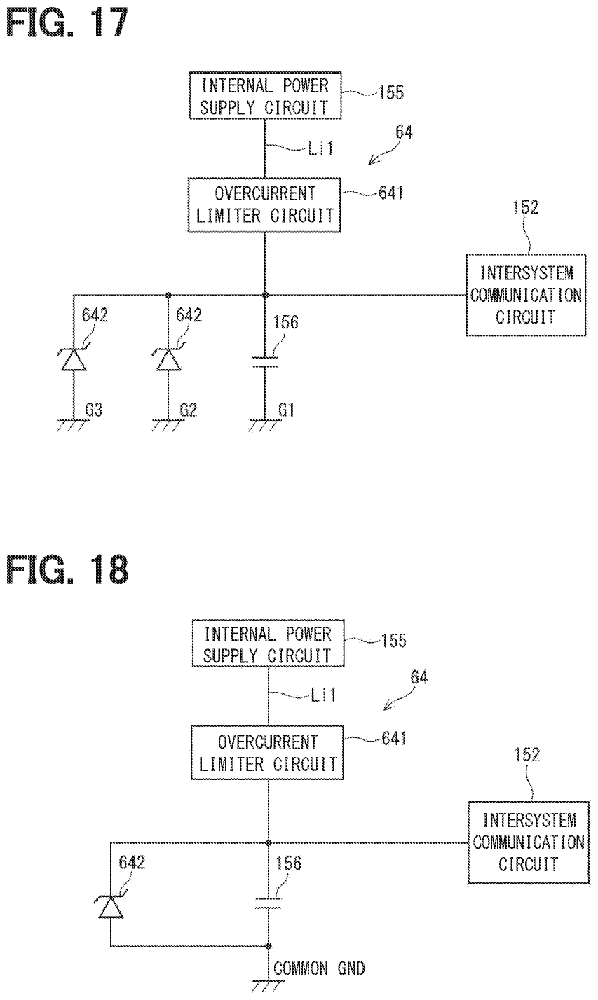

As shown in FIG. 17, when there are three or more systems and the ground in each individual system is isolated, the Zener diode 642 is provided for each system and is connected to the ground of each system. As shown in FIG. 18, when multiple systems have a common ground, the anode side of the Zener diode 642 is connected to the common ground.

The protection circuit 64 according to the present embodiment includes the overcurrent limiter circuit 641 provided at the output unit of the internal power supply circuit 155, and can limit the power supply to the intersystem communication circuit 152 when an overvoltage abnormality occurs. Therefore, when the overvoltage of the internal power supply voltage Vmi occurs, it is possible to appropriately limit the voltage applied to the intersystem communication circuit 152. Further, the similar advantageous effects to those of the embodiment described above can also be achieved.

In the present disclosure, the ECU 10 corresponds to a control unit; the motor 80 corresponds to a load; each of the microcomputers 150, 250 corresponds to a controller; and an internal power supply voltage Vmi corresponds to an output voltage of an internal power supply circuit.

### Other Embodiments

In the above embodiments, the number of systems is two or three. In other embodiments, the number of systems may be four or more. In the above embodiments, the load is the motor. In other embodiments, the load may be a generator, or may be a so-called motor generator having the functions of an electric motor and a generator, or may be other devices different from the motor. In the above embodiment, the control unit is applied to the electric power steering apparatus. In other embodiments, the control unit may be applied to other apparatuses different from the electric power steering apparatus.

The controller and the technique according to the present disclosure may be achieved by a dedicated computer provided by constituting a processor and a memory programmed to execute one or more functions embodied by a computer program. Alternatively, the controller and the method described in the present disclosure may be realized by a dedicated computer configured as a processor with one or more dedicated hardware logic circuits. Alternatively, the controller and method described in the present disclosure may be realized by one or more dedicated computer, which is configured as a combination of a processor and a memory, which are programmed to perform one or more functions, and a processor which is configured with one or more hardware logic circuits. The computer programs may be stored, as instructions to be executed by a computer, in a tangible non-transitory computer-readable medium. The present disclosure is not limited to the embodiments described above, and can be implemented in various forms without departing from the spirit of the present disclosure.

The present disclosure has been made in accordance with the embodiments. However, the present disclosure is not limited to such embodiments and configurations. The present disclosure also encompasses various modifications and variations within the scope of equivalents. Furthermore, various combination and formation, and other combination and formation including one, more than one or less than one element may be made in the present disclosure.

What is claimed is:

1. A control unit comprising:
a plurality of controllers configured to control a load, the plurality of controllers being connected to respective circuit arrangements, the respective circuit arrangements being defined as systems;
an intersystem communication circuit connecting one of the systems to another of the systems;
an internal power supply circuit being included in each of the systems, the internal power supply circuit configured to supply electric power to the intersystem communication circuit and a corresponding one of the plurality of controllers; and
a protection circuit configured to cut off an internal power supply line between the internal power supply circuit and the intersystem communication circuit or limit supply of the electric power to the intersystem communication circuit, in response to an occurrence of an overvoltage abnormality in which an output voltage of the internal power supply circuit is in an overvoltage state.

2. The control unit according to claim 1, wherein
each of the systems has an isolated ground,
the protection circuit is included in each of the systems, and
the protection circuit in a corresponding one of the systems is connected to the isolated ground in a system being different from the corresponding one of the systems.

3. The control unit according to claim 1, wherein
the protection circuit includes:
a fuse being connected to the internal power supply line; and
a Zener diode being connected to a wiring, the wiring being connected between a ground and an end of the fuse, the end of the fuse being connected to the intersystem communication circuit.

4. The control unit according to claim 3, wherein
the fuse is a chip current fuse or a chip resistor,
the chip current fuse is configured to be mounted on a board, and
the chip resistor is configured to be disconnected at a voltage lower than a Zener voltage of the Zener diode.

5. The control unit according to claim 3, wherein
the fuse is a bonding wire inside an integrated circuit included in the internal power supply circuit,
the bonding wire is connected to an output terminal of the integrated circuit, and
the output terminal is connected to the intersystem communication circuit.

6. The control unit according to claim 3, wherein
the fuse is a fuse pattern included in a wiring pattern on a board,
the wiring pattern forms a current path connecting the internal power supply circuit and the intersystem communication circuit, and
the fuse pattern is locally slimmer than another pattern located in the wiring pattern.

7. The control unit according to claim 1, wherein
the protection circuit includes:
a switching element being connected to the internal power supply line; and
a Zener diode being connected between the internal power supply line and a ground, and
the switching element is configured to be:
turned on in a case where the output voltage is in a normal state; and
turned off due to a current flow toward the Zener diode in a case where the output voltage is in the overvoltage state.

8. The control unit according to claim 1, wherein
the protection circuit includes:
an overvoltage detection circuit configured to monitor the output voltage; and
a cutoff relay being connected to the internal power supply line, the cutoff relay configured to be turned off in a case where the overvoltage detection circuit detects that the output voltage is in the overvoltage state.
